(19) United States
(12) Patent Application Publication
(10) Pub. No.: US 2026/0299725 A1
(43) Pub. Date: Oct. 1, 2026

(54) CAPACITIVE TOUCH SENSING APPARATUS AND TOUCH SENSING METHOD

(71) Applicant: FOCAL TECH SYSTEMS (SHENZHEN) CO., LTD., Shenzhen (CN)

(72) Inventors: BEI XIAO, Shenzhen, Guangdong (CN); JING-KAI ZHANG, Shenzhen, Guangdong (CN); ZHI-QIANG LUO, Shenzhen, Guangdong (CN); XIAO-LIN HUANG, Shenzhen, Guangdong (CN)

(21) Appl. No.: 19/489,336

(22) PCT Filed: Jun. 2, 2023
(86) PCT No.: PCT/CN2023/098152

§ 371 Date: Dec. 2, 2025

(51) Int. Cl. G06F 3/041; G06F 3/044

(52) U.S. Cl. CPC G06F 3/0418; G06F 3/0446

(57) ABSTRACT

A capacitive touch sensing apparatus and a touch sensing method are provided. The capacitive touch sensing apparatus includes a touch panel with a touch electrode laver and a touch sensing control circuit. At a first moment, the touch sensing control circuit outputs first driving signals to a part of driving electrodes, outputs second driving signals to the rest of the driving electrodes, and and calculates capacitance of each of the sensing capacitors formed by the sensing electrodes. At a second moment, the touch sensing control circuit outputs third driving signals to each of the driving electrodes and calculates capacitance of each of the sensing capacitors. The touch sensing control circuit further calculates a capacitance change between the first moment and the second moment. When the capacitance change is larger than or equal to the predefined value, the touch sensing control circuit confirms a touch object as a grounding conductor.

### TECHNICAL FIELD

The present application generally relates to touch sensing technology, and particular to a capacitive touch sensing apparatus and a touch sensing method.

### BACKGROUND

A capacitive touch display apparatus includes a self-capacitance type and a mutual-capacitance type. Using the mutual-capacitance type touch sensing apparatus as an example, the mutual-capacitance type touch sensing apparatus includes at least one driving electrode and at least one sensing electrode under a cover plate. While executing a touch sensing, the driving electrodes are driven by a driving voltage, and sensing capacitance between the sensing electrode and the driving electrode are sensed. When a finger or a grounding conductor is used to execute a touch operation on the cover plate, the sensing capacitance of the sensing capacitor will changed. When there is non-grounding conductor (such as water drop, spray, coin, and so on) on the cover plate, the sensing capacitance of the sensing capacitor will also change, thereby the non-grounding conductor will identified as the grounding conductor by the touch sensing apparatus, and a mis-sense is caused.

### SUMMARY

An aim of the present application is to provide a capacitive touch sensing apparatus and a touch control sensing method, in order to solve the technology problems in a prior art of a negative impact on how to avoid the non-grounding conductor being mis-sensed.

A capacitive touch sensing apparatus, includes a touch panel and a touch sensing control circuit, the touch panel includes a touch electrode layer. The touch electrode layer is patterned into a plurality of first electrodes arranged along a first direction and a plurality of second electrodes arranged along a second direction. The touch sensing control circuit is electrically connected with the first electrodes and the second electrodes. A touch sensing period includes at least one moment and at least one second moment. In the first moment and the second moment, the first electrodes are configured to be driving electrodes, and the second electrodes are configured to be sensing electrodes. In the first moment, the touch sensing control circuit outputs first driving signals to a part of the driving electrodes, provides second driving signals to the rest of the driving electrodes, and calculates capacitances of sensing capacitors formed by each of sensing capacitors. The first driving signals and the second driving signals are pulse signals with at least one difference in frequency, phase, and amplitude. In the second moment, the touch sensing control circuit provides third driving signals to all of the driving electrodes and calculates the capacitances of the sensing capacitors. The third driving signals are pulse signals in a same frequency, a same phase, and a same amplitude. The touch sensing control circuit further calculates a capacitance change of the capacitance of the sensing capacitor formed by a same sensing capacitor at the first moment and the second moment, and compares the capacitance change with a predefined value. When the capacitance change is larger than or equal to the predefined value, the touch sensing control circuit confirms a touch object at corresponding positions of the sensing electrodes as a grounding conductor. When the capacitance change is less than the predefined value, the touch sensing control circuit confirms the touch object at the corresponding positions of the sensing electrodes as a non-grounding conductor.

Besides, for achieving the foregoing aim, the present application further provides a touch sensing method, applied in a capacitive touch sensing apparatus. The capacitive touch sensing apparatus includes a touch panel and a touch sensing control circuit. The touch panel includes a touch electrode layer. The touch electrode layer is patterned into a plurality of first electrodes arranged along a first direction and a plurality of second electrodes arranged along a second direction. In a touch sensing period, the first electrodes and the second electrodes are configured to be driving electrode and sensing electrodes respectively. The touch sensing method includes:
Setting the first electrodes as driving electrodes and setting the second electrodes as sensing electrodes;
At a first moment, providing first driving signals to a part of the driving electrodes, providing second driving signals to the rest of the driving electrodes, and calculating capacitances of sensing capacitors formed by the sensing electrodes;
At a second moment, providing third driving signals to all of the driving electrodes and calculating the capacitances of the sensing capacitors generated by the sensing electrodes;
Calculating a capacitance change of the capacitance of the sensing capacitor formed by a same sensing capacitor at the first moment and the second moment;
Determining whether the capacitance change is larger than or equal to a predefined value;
Confirming a touch object at corresponding positions of the sensing electrodes as a grounding conductor, when the capacitance change is larger than or equal to a predefined value;
Confirming the touch object at corresponding positions of the sensing electrodes as a non-grounding conductor, when the capacitance change is less than the predefined value;
Wherein the first driving signals and the second driving signals are pulse signals with at least one difference in frequency, phase, and amplitude; the third driving signals are pulse signals in a same frequency, a same phase, and a same amplitude.

The foregoing capacitive touch sensing apparatus and the touch sensing method, by providing the phase signals with at least one difference in frequency, phase, and amplitude to the driving electrodes at a moment in the touch sensing period, and providing the phase signals in a same frequency, a same phase, and a same amplitude to the driving electrodes in another moment in the touch sensing period, a change degree of the capacitance of a same sensing capacitor in different moments are detected, when the change degree is smaller, the non-grounding conductor is confirmed, a mis-sensing generated by the non-grounding conductor is excluded, a mis-sense generated by the capacitive touch sensing apparatus are avoided, an accuracy in touch sensing of the capacitive touch sensing apparatus is improved.

### BRIEF DESCRIPTION OF THE DRAWINGS

To illustrate the technical solutions in the embodiments of the present invention or in the prior art more clearly, accompanying drawings need for describing the embodiments or the prior art are briefly introduced in the following. Obviously, the accompanying drawings in the following description are only some embodiments of the present invention, and person of ordinary skill in the art may obtain other accompanying drawings from these accompanying drawings without making creative efforts.

FIG. 1 is a schematic view of a capacitive touch sensing apparatus of an exemplary embodiment of the present application.

FIG. 2 is a block schematic view of the touch electrode layer of FIG. 1.

FIG. 3 is a schematic view of the touch electrode layer and corresponding loading signals at a first moment t1.

FIG. 4 is a schematic view of the touch electrode layer and corresponding loading signals at a second moment t2.

FIG. 5 is a schematic view of capacitance changes of sensing capacitors of sensing electrodes in the first moment t1 and the second moment t2.

FIG. 6 is a flowchart of a touch sensing method of an exemplary embodiment of the present application.

FIG. 7 is a flowchart of the touch sensing method of FIG. 6.

Description of symbols for main components

| | |
|---|---|
| Capacitive touch display apparatus | 1 |
| Touch panel | 10 |
| Display panel | 20 |
| Cover plate | 11 |
| Touch electrode layer | 12 |
| First electrodes | 121_1~121_m |
| Second electrodes | 123_1~123_n |
| Driving electrodes | Tx1~Txm, Tx1~Txn |
| Sensing electrodes Ï | Rx1~Rxn, Rx1~Rxm |
| Touch display region | 101 |
| Non-display region | 103 |
| Touch sensing control circuit | 30 |
| Touch sensing line | 301 |
| Steps | S600~S614 |

The present disclosure will be further described by the following specific embodiments in conjunction with the above figures.

### DETAILED DESCRIPTION

The present disclosure is described with reference to accompanying drawings and the embodiments. It will be understood that the specific embodiments described herein are merely part of all embodiments, not all the embodiments. Based on the embodiments of the present disclosure, it is understandable to a person skilled in the art, any other embodiments obtained by persons skilled in the art without creative effort shall all fall into the scope of the present disclosure.

Terms “first”, “second”, and “third”, and the like used in the specification, the claims, and the accompanying drawings of the present disclosure are used to distinguish different objects rather than describe a particular order. Besides, a term “comprise” and its variations are intended to cover a non-exclusive inclusion.

Unless otherwise specified, all technical and scientific terms have the ordinary meanings as understood by people skilled in the art. The terms used in this disclosure are illustrative rather than limiting. Terms “and/or” used in the specification, includes any and all combinations of one or more of the associated listed terms.

The detail embodiment of a capacitive touch sensing apparatus and a touch sensing method of the present application will be described with reference to accompanying drawings as follow.

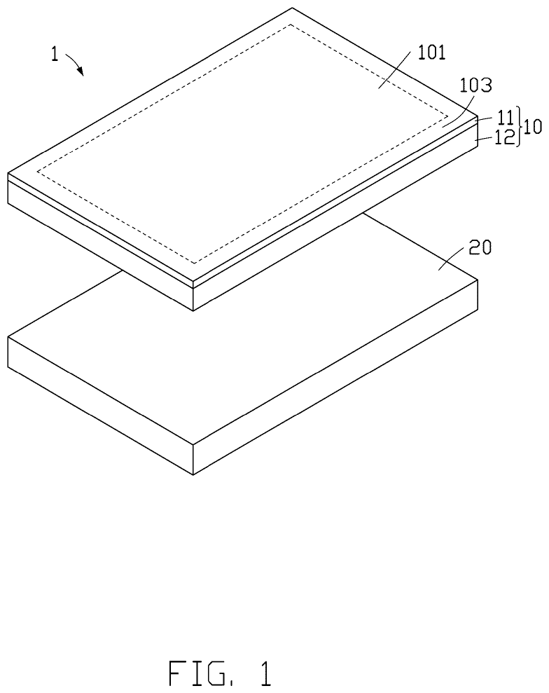

Referring to FIG. 1, FIG. 1 shows a schematic view of a capacitive touch sensing apparatus 1 of an exemplary embodiment of the present application. The capacitive touch display apparatus 1 may be a removable device, such as a personal computer, a planet, a mobile phone, a personal digital assistance (PDA), a game machine, an Internet protocol television (IPTV), a smart wearable device, a navigation apparatus, and so on. The capacitive touch sensing apparatus 1 may further include one or more functions, such as fingerprint identification function, a display function, and a camera function.

The capacitive touch sensing apparatus 1 includes a touch panel 10 and a display panel 20. The touch panel 10 is configured to sense touch operations of users. The touch panel 10 includes a cover plate 11 and a touch electrode layer 12, which are overlapped from upper to lower in that order by viewed from a direction facing to the capacitive touch sensing apparatus 1.

The cover plate 11 may be a glass substrate, or a transparent substrate with a higher intensity and a higher hardness. In one embodiment of the present application, a material of the cover 11 may be polycarbonate (PC), polyethylene terephthalate (PET), polymethylmethacrylate (PMMA), cyclic olefin copolymer (COC), or polyether sulfone (PES), and the like.

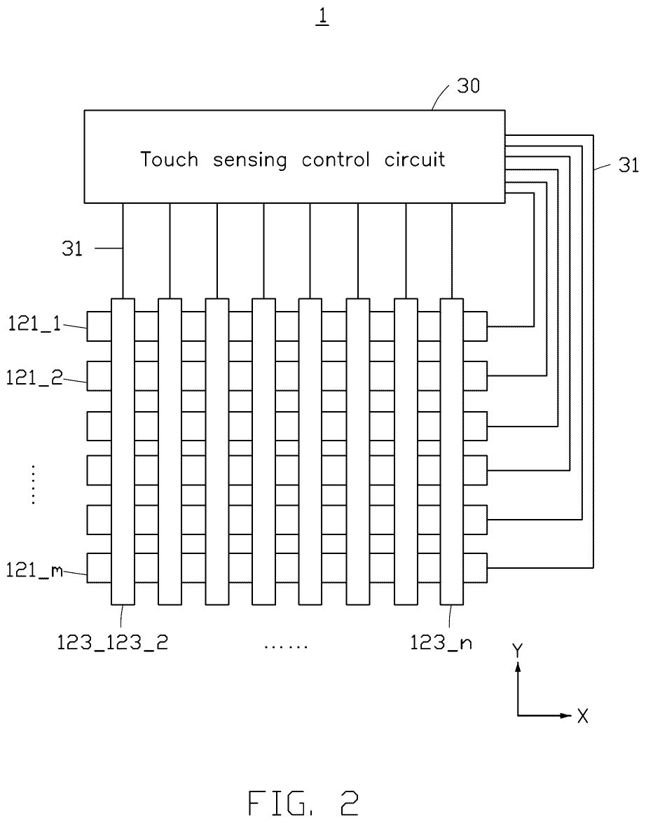

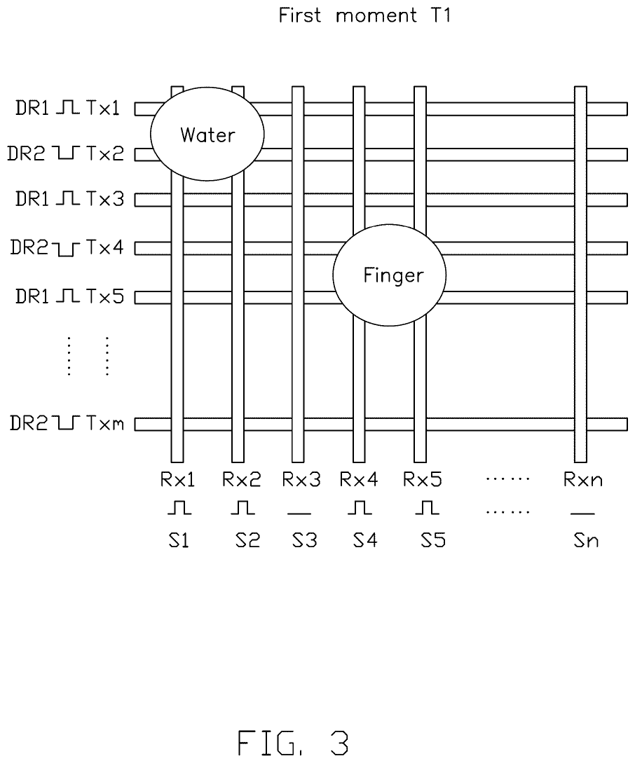

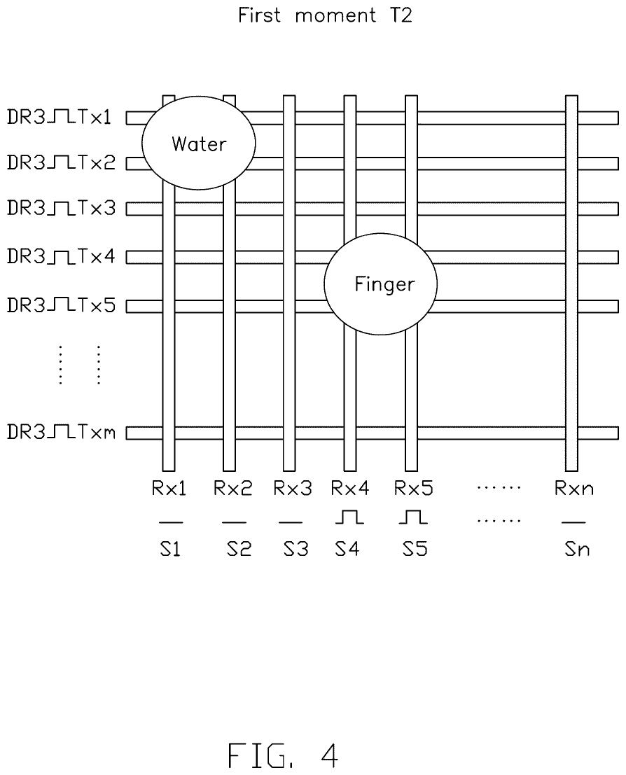

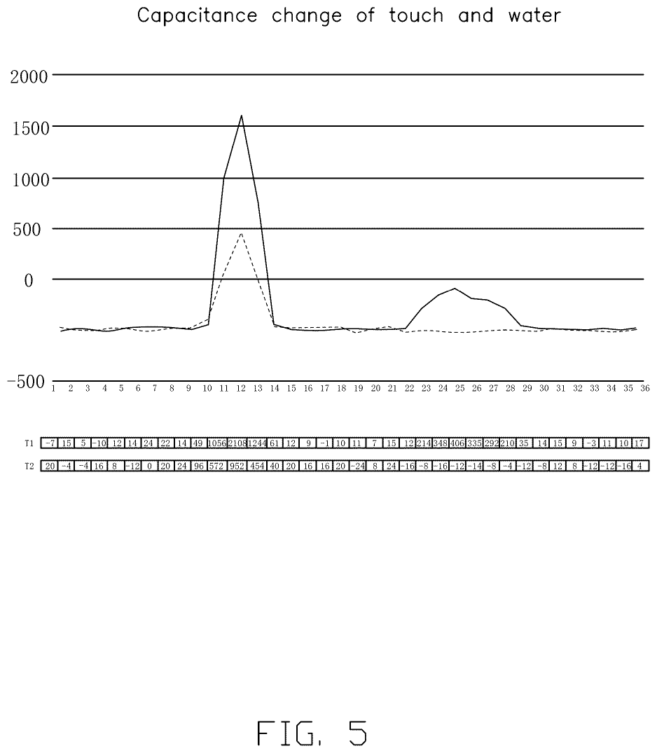

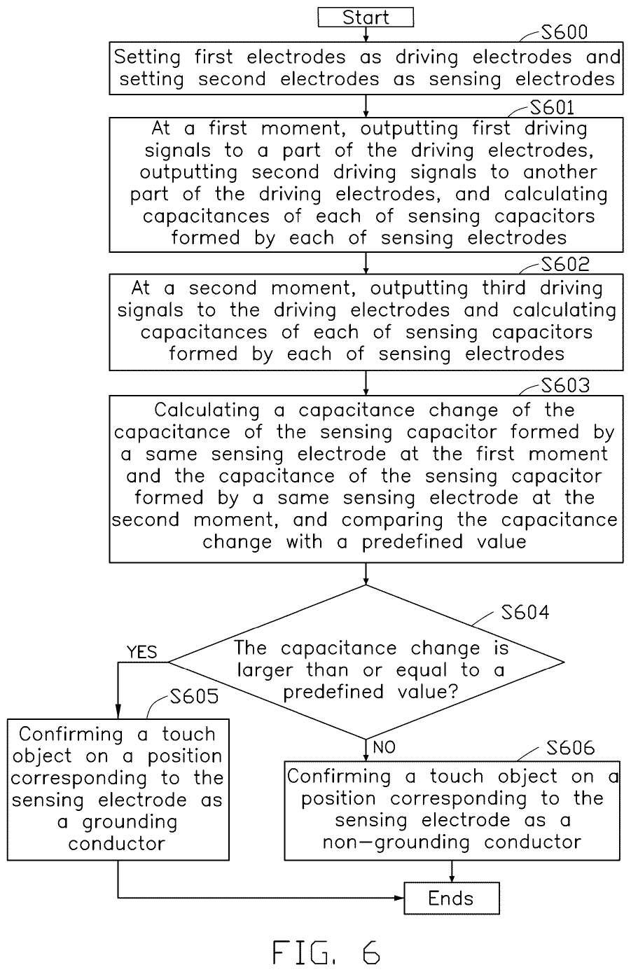

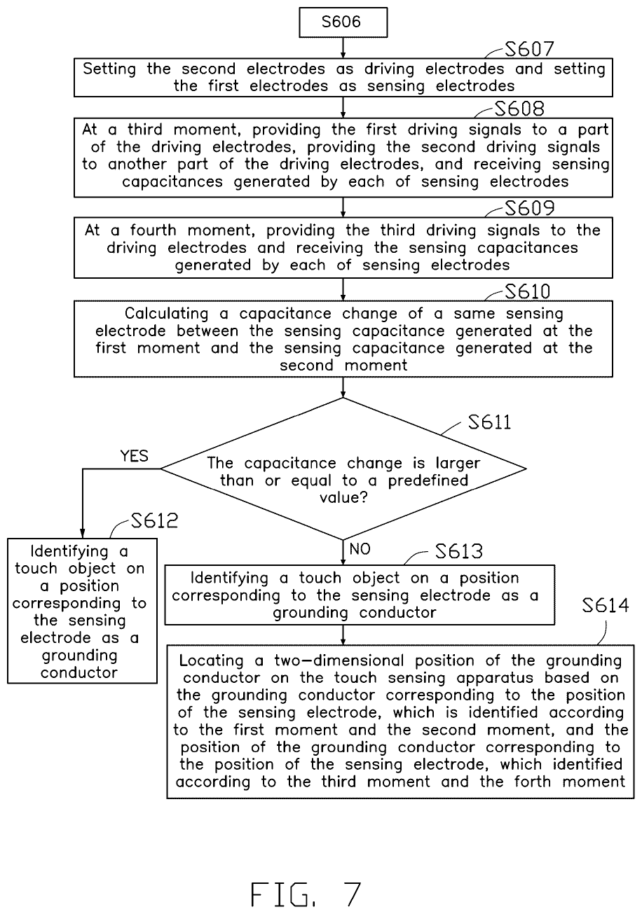

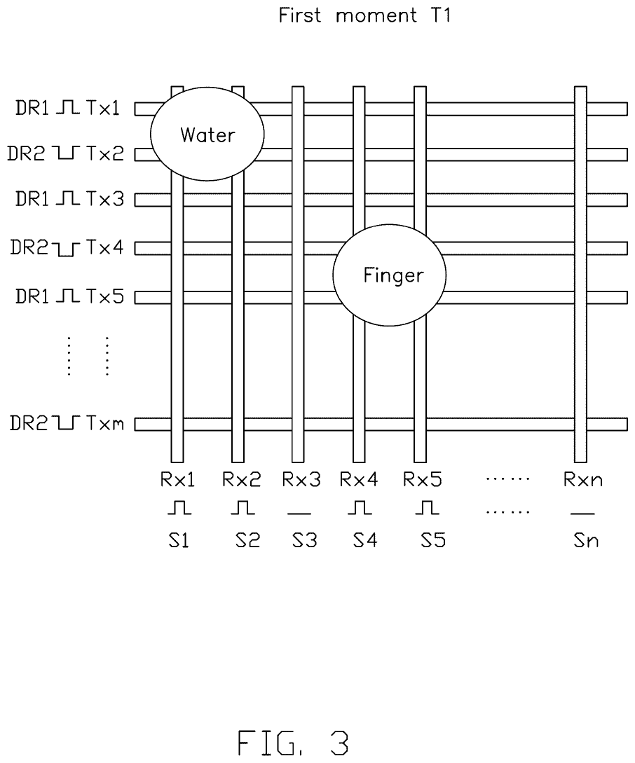

Referring to FIG. 2 together, which is a schematic view of the touch electrode layer 12. The touch electrode layer 12 is made of conductive material, and is patterned into a plurality of first electrodes 121_1~121_m and a plurality of second electrodes 123_1~123_n, m and n are positive integer, which may be same or different from each other. The plurality of first electrodes 121_1~121_m are extended along a first direction X and are parallel with each other. The plurality of second electrodes 123_1~123_n are extended along a second direction Y and are parallel with each other. In one embodiment of the present application, the first direction X is perpendicular to the second direction Y In other embodiments, the first direction X and the second direction Y may be set and crossed in other angles. In any moment of a touch sensing period T1 (as shown in FIG. 3), some of the first electrodes 121_1~121_m and the second electrodes 123_1~123_n are configured to be driving electrodes Tx1-Txm (as shown in FIG. 3), and others of the first electrodes 121_1~121_m and the second electrodes 123_1~123_n are configured to be sensing electrodes Rx1~Rxn (as shown in FIG. 3). When there is a grounding conductor (such as a finger or a touch pen) existed on the cover plate 11, capacitances of the sensing capacitor formed by the sensing electrode Rx and the driving electrodes are reduced. In one embodiment of the present application, the touch electrode layer 12 may be a single conductive structure, for forming a self-capacitor touch sensing structure. In other embodiments, the touch electrode layer 12 further may be multiple-layer conductive structure, for forming a mutual capacitance touch sensing structure.

The display panel 20 is below the touch panel 10, and is configured to display images. In one embodiment of the present application, the display panel 20 is an organic light emitting diode (OLED), and the display panel 20 includes a first electrode layer, a second electrode layer, a hole injection layer, a hole transport layer, an emitting layer, and an electronic transport layer. In other embodiments, the display panel 20 also may be a liquid crystal structure or other display structures.

Further, referring to FIG. 1, the capacitive touch sensing apparatus 1 defines a touch display region 101 and a non-display region 103 surrounding the touch display region 101. The plurality of first electrodes 121_1~121_m and the plurality of second electrodes 123_1~123_n are disposed in the touch display region 101, and extends into the non-display region 103.

Referring to FIG. 2, the capacitive touch sensing apparatus 1 further includes a touch sensing control circuit 30. The touch sensing control circuit 30 may be disposed in the non-display region 103, and are electrically connected with the plurality of first electrodes 121_1~121_m and the plurality of second electrodes 123_1~123_n through touch sensing lines 301. The touch sensing control circuit 30 is configured to output driving signals to the driving electrodes Tx1~Txm in a touch sensing period T1, and receive sensing capacitances generated by the sensing electrodes. In one embodiment of the present application, the touch sensing control circuit 30 sets the first electrodes 121_1~121_m as the driving electrodes Tx1~Txm, and sets the second electrodes 121_1~121_m as the sensing electrodes Rx1~Rxn.

A detail working principle of the capacitive touch sensing apparatus 1 is described as below.

The touch sensing period T1 includes at least one first moment t1 and at least one second moment. The first moment t1 and the second moment t2 are alternately spaced.

Referring to FIG. 3 together, FIG. 3 is a diagram view of the touch electrode layer 12 and corresponding loading signals at a first moment t1. In the first moment t1, the touch sensing control circuit 30 outputs first driving signals DR1 to a part of the driving electrodes Tx1~Txm, outputs second driving signals DR2 to the rest of the driving electrodes Tx1~Txm, and calculates capacitances of sensing capacitors S1~Sn formed by the sensing electrodes Rx1~Rxn. The first driving signals DR1 and the second driving signals DR2 are not in-phase signals. In at least one embodiment of the present application, the first driving signals and the second driving signals are pulse signals with at least one difference in frequency, phase, and amplitude. The in-phase signals are pulse signals in a same frequency, a same phase, and a same amplitude. It is understood that, the same phase and the same amplitude may exist a light deviation due to a signal loss or other reasons, but the frequency must be same. As shown in FIG. 3, the first driving signals DR1 and the second driving signals DR2 are pulse signals with different frequencies phases, and amplitudes.

In at least one embodiment of the present application, in the first moment t1, the touch sensing control circuit 30 outputs the first driving signals DR1 to odd number of the driving electrodes Tx1~Txm, and outputs the second driving signal DR2 to even number of the driving electrodes Tx1~Txm. In other embodiments, in the first moment t1, the touch sensing control circuit 30 may outputs the first driving signals DR1 or the second driving signals DR2 to some of the driving electrodes Tx1~Txm at a specified position. For example, the touch sensing control circuit 30 may output the first driving signals DR1 to the driving electrodes Tx2~Tx(m−1) disposed in the middle of the touch display region 101, and output the second driving electrodes DR2 to the driving electrode Tx1 and the driving electrodes Txm, which are disposed on edges of the touch display region 101.

In at least one embodiment of the present application, in the first moment t1, the touch sensing control circuit 30 calculates the capacitances of each of the sensing capacitors S1~Sn formed by the sensing electrodes Rx1~Rxn. Under this model, a cost of the capacitive touch sensing apparatus 1 is high, but a sensing age of the signal is quick. In other embodiments, the touch sensing control circuit 30 may calculates the capacitances of each of the sensing capacitors S1~Sn formed by the sensing electrodes Rx1~Rxn in a time division manner. For example, in the first moment t1, the touch sensing control circuit 30 calculates the capacitances of each of the sensing capacitors S1~Si formed by the sensing electrodes Rx1~Rxi, at other moments between the first moment t1 and the second moment t2, the touch sensing control circuit 30 calculates the capacitances of each of the sensing capacitors S(i+1)~Sn formed by the sensing electrodes Rx(i+1)~Rxn. Wherein, i is a positive integer, which is larger than 1, and is less then n. Under this model, the cost of the capacitive touch sensing apparatus 1 is low, and the sensing age of the signal is low.

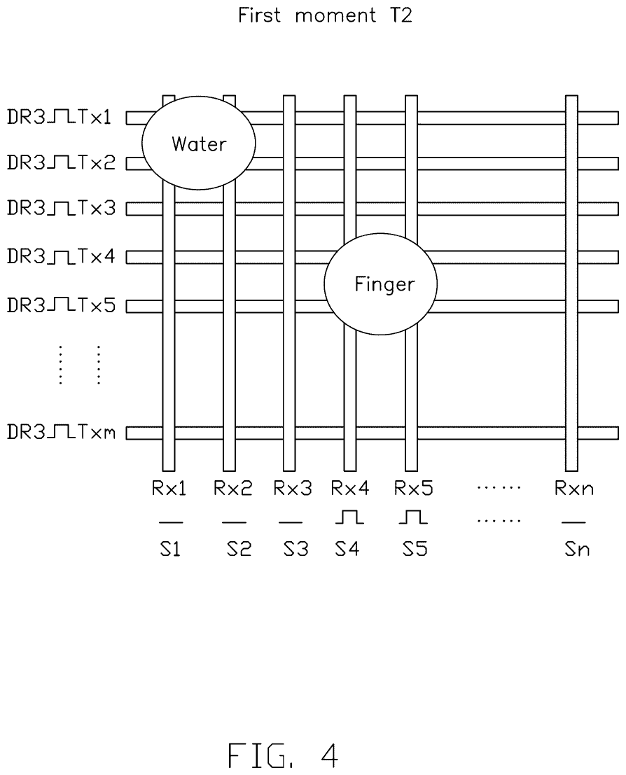

Referring to FIG. 4, FIG. 4 is a diagram view of the touch electrode layer 12 and corresponding loading signals at a second moment t2. In the second moment t2, the touch sensing control circuit 30 outputs the third driving signals DR3 to the driving electrodes Tx1~Txm and calculates the capacitances of each of the sensing capacitors formed by the sensing electrodes Rx1~Rxn. The third driving signals DR3 received by each of the driving electrodes Tx1~Txm are in-phase signals.

In at least one embodiment of the present application, the third driving signals DR3 and the first driving signals DR1 are in-phase signals. In other embodiments, the third driving signals DR3 and the second driving signals DR2 may be in-phase signals. Or, the third driving signals DR3 may be signals being different from the first driving signals DR1 and the second driving signals DR2.

The touch sensing control circuit 30 calculates a capacitance change of the capacitance of the sensing capacitor formed by a sensing electrode Rxi of the sensing electrodes Rx1~Rxn at the first moment t1 and the capacitance of the sensing capacitor formed by the sensing electrode Rxi at the second moment t2. When the capacitance change is larger than or equal to a predefined value, the touch sensing control circuit 30 confirms a touch object at a corresponding position of the sensing electrode Rxi as a non-grounding conductor (such as water drop, spray, and coin, and the like). When the capacitance change is less than the predefined value, the touch sensing control circuit 30 confirms a touch object at a corresponding position of the sensing electrode Rxi as a grounding conductor.

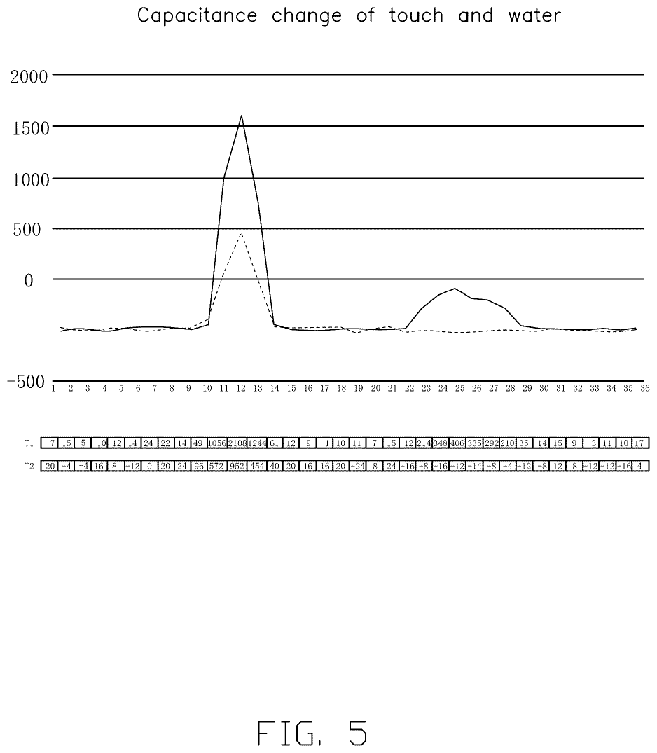

Referring to FIG. 5, FIG. 5 is a schematic view of capacitance changes of the sensing capacitors formed by the sensing electrodes RX1~RX36 in the first moment t1 and the second moment t2. By supposing the predefined value to be 500 units, the sensing capacitance of the sensing capacitor Rx11 in the first moment t1 is 1506 units, the sensing capacitance of the sensing capacitor Rx11 in the second moment t2 is 572 units; the sensing capacitance of the sensing capacitor Rx12 in the first moment t1 is 2108 units, the sensing capacitance of the sensing capacitor Rx12 in the second moment t2 is 952 units; the sensing capacitance of the sensing capacitor Rx13 in the first moment t1 is 1244 units, the sensing capacitance of the sensing capacitor Rx13 in the second moment t2 is 464 units. The capacitance change of the sensing capacitor Rx11 between the first moment t1 and the second moment t2 is 934 units, which is larger than the predefined value, thus the touch sensing control circuit 30 confirms the touch object at the position corresponding to the sensing electrode Rx11 as the grounding conductor. Similarly, the touch sensing control circuit 30 confirms the touch objects at the positions corresponding to the sensing electrodes Rx12~Rx13 as the grounding conductor.

Meanwhile, the sensing capacitance of the sensing capacitor Rx23 in the first moment t1 is 214 units, the sensing capacitance of the sensing capacitor Rx23 in the second moment t2 is −8 units; the sensing capacitance of the sensing capacitor Rx24 in the first moment t1 is 348 units, the sensing capacitance of the sensing capacitor Rx24 in the second moment t2 is −16 units; the sensing capacitance of the sensing capacitor Rx25 in the first moment t1 is 406 units, the sensing capacitance of the sensing capacitor Rx25 in the second moment t2 is −12 units; the sensing capacitance of the sensing capacitor Rx26 in the first moment t1 is 316 units, the sensing capacitance of the sensing capacitor Rx26 in the second moment t2 is −16 units; the sensing capacitance of the sensing capacitor Rx27 in the first moment t1 is 292 units, the sensing capacitance of the sensing capacitor Rx27 in the second moment t2 is −8 units; the sensing capacitance of the sensing capacitor Rx28 in the first moment t1 is 210 units, the sensing capacitance of the sensing capacitor Rx28 in the second moment t2 is 222 units, which is less than the predefined value, thus the touch sensing control circuit 30 confirms the touch object at the position corresponding to the sensing capacitor Rx23 as a non-grounding conductor. Similarly, the touch sensing control circuit 30 confirms the touch objects at the positions corresponding to the sensing electrodes Rx24~Rx28 as the grounding conductor.

In other embodiments, the touch sensing control circuit 30 may outputs the third driving signals DR3 to the driving electrodes Tx1~Txm in the first moment t1 and calculates the capacitance of each of the sensing capacitors formed by each of the sensing electrodes Rx1~Rxn. The third driving signals DR3 received by the driving electrodes Tx1~Txm are in-phase signals. The touch sensing control circuit 30 outputs the first driving signals DR1 to a part of the driving electrodes Tx1~Txm in the second moment t2, outputs the second driving signals DR2 to the rest of the driving electrodes Tx1~Txm, and calculates the capacitance of each of the sensing capacitors S1~Sn formed by the sensing electrodes Rx1~Rxn.

In another embodiment, the touch sensing period T1 further includes at least a third moment t3 and at least one fourth moment t4. The touch sensing control circuit 30 operates under the first to fourth moments t1~t4 in sequence. In the third moment t3 and the fourth moment t4, the first electrodes 121_1~121_m are configured to be the sensing electrodes Rx1~Rxm, the second electrodes 123_1~123_n are configured to be the driving electrodes Tx1~Txn. In the third moment t3, the touch sensing control circuit 30 repeatedly executes the operation in the foregoing first moment t1; in the fourth moment t4, the touch sensing control circuit 30 repeatedly executes the operation in the foregoing second moment t2; no detail will be described at here. The touch sensing control circuit 30 further locates a two-dimensional position of the grounding conductor on the capacitive touch sensing apparatus 1 based on the position of the sensing electrode Rxi corresponding to the grounding conductor. One coordinate of the position of the grounding conductor is calculated based on the position of the corresponding sensing electrode Rxi, which is confirmed based on the capacitance change between the first moment t1 and the second moment t2, and another coordinate of the position of the grounding conductor is calculated based on the position of the corresponding sensing electrode Rxk, which is confirmed based on the capacitance change between the third moment t3 and the fourth moment t4.

The foregoing capacitive touch sensing apparatus 1, by outputting the driving signals being non in-phase signals to the driving electrodes at one moment in the touch sensing period T1, and outputting driving signals being in-phase signals to each of the driving electrodes, a change degree of the sensing capacitor of a same sensing electrode at different moments are compared. While the change degree of the sensing capacitor is small, the non-grounding conductor is confirmed, for excluding a mis-sensing generated by the non-grounding conductor, therefore a mis-sense generated by the capacitive touch sensing apparatus 1 is avoided, for improving an accuracy in touch sensing of the capacitive touch sensing apparatus 1.

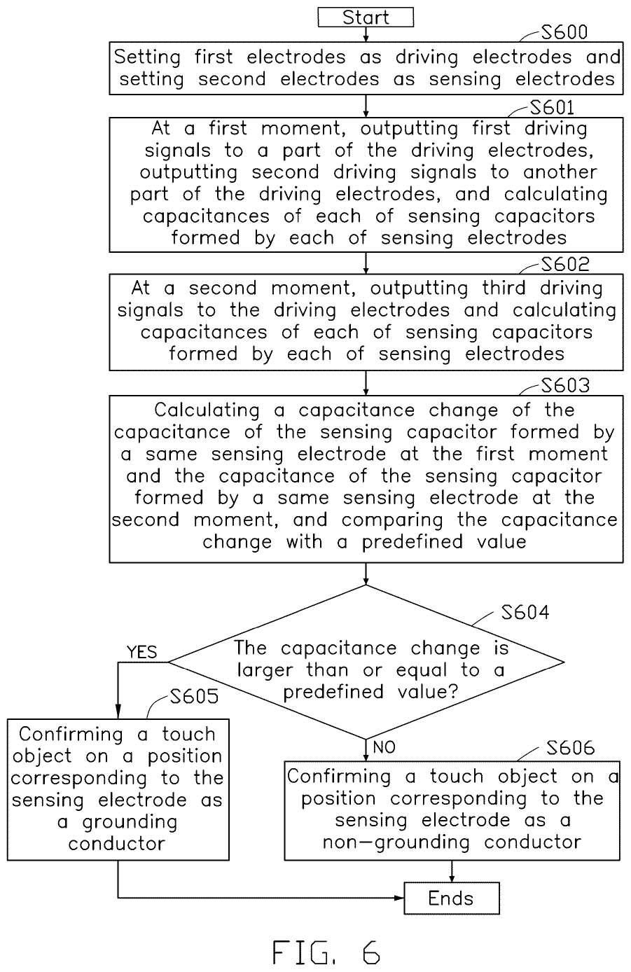

Referring to FIG. 6, FIG. 6 is a flowchart of a touch sensing method. In one embodiment of the present application, the touch sensing method is applied in the capacitive touch sensing apparatus 1. The touch sensing method includes following steps.

In block S600, the first electrodes 121_1~121_m are set as driving electrodes Tx1~Txm, and the second electrodes 123_1~123_n are set as sensing electrodes Rx1~Rxn.

In block S601, at a first moment t1, first driving signals DR1 are outputted to a part of the driving electrodes Tx1~Txm, second driving signals DR2 are outputted to the rest of the driving electrodes Tx1~Txm, capacitances of each of sensing capacitors S1~Sn formed by each of the sensing electrodes Rx1~Rxn are calcuated.

Wherein, the first driving signals DR1 and the second driving signals DR2 are not in-phase signals. In at least one embodiment of the present application, the first driving signals DR1 and the second driving signals DR2 are pulse signals with at least one difference in frequency, phase, and amplitude. The in-phase signals are pulse signals in a same frequency, a same phase, and a same amplitude. It is understood that, the same phase and the same amplitude may exist a light deviation due to a signal loss or other reasons, but the frequency must be same. As shown in FIG. 3, the first driving signals DR1 and the second driving signals DR2 are pulse signals with different frequencies phases, and amplitudes.

In one embodiment of the present application, in the first moment t1, the touch sensing control circuit 30 outputs the first driving signals DR1 to odd number of the driving electrodes Tx1~Txm, and outputs the second driving signal DR2 to even number of the driving electrodes Tx1~Txm. In other embodiments, in the first moment t1, the touch sensing control circuit 30 may output the first driving signals DR1 or the second driving signals DR2 to some of the driving electrodes Tx1~Txm at a specified position. For example, the touch sensing control circuit 30 may output the first driving signals DR1 to the driving electrodes Tx2~Tx(m−1) disposed in the middle of the touch display region 101, and output the second driving electrodes DR2 to the driving electrode Tx1 and the driving electrodes Txm, which are disposed on edges of the touch display region 101.

In at least one embodiment of the present application, in the first moment t1, the touch sensing control circuit 30 calculates the capacitances of the sensing capacitors S1~Sn formed by the sensing electrodes Rx1~Rxn. Under this model, a cost of the capacitive touch sensing apparatus 1 is high, but a sensing age of the signal is quick. In other embodiments, the touch sensing control circuit 30 may calculate the capacitances of each of the sensing capacitors S1~Sn formed by the sensing electrodes Rx1~Rxn in a time division manner. For example, in the first moment t1, the touch sensing control circuit 30 calculates the capacitances of each of the sensing capacitors S1~Si formed by the sensing electrodes Rx1~Rxi, at other moments between the first moment t1 and the second moment t2, the touch sensing control circuit 30 calculates the capacitances of each of the sensing capacitors S(i+1)~Sn formed by the sensing electrodes Rx(i+1)~Rxn. Wherein, i is a positive integer, which is larger than 1, and is less then n. Under this model, the cost of the capacitive touch sensing apparatus 1 is low, and the sensing age of the signal is low.

In block S602, at a second moment t2, third driving signals DR3 are outputted to each of the driving electrodes Tx1~Txm, and the capacitances of each of the sensing capacitors Si~Sn formed by each of the sensing electrodes Rx1~Rxn are calculated.

In at least one embodiment of the present application, the third driving signals DR3 and the first driving signals DR1 are in-phase signals. In other embodiments, the third driving signals DR3 and the second driving signals DR2 may be in-phase signals. Or, the third driving signals DR3 may be signals being different from the first driving signals DR1 and the second driving signals DR2.

In block S603, a capacitance change of the capacitance of the sensing capacitor Si_t1 formed by a same sensing electrode Rxi at the first moment t1 and the capacitance of the sensing capacitor Si_t2 formed by a same sensing electrode Rxi at the second moment t2 is calculated.

In block S604, determining whether the capacitance change is larger than or equal to a predefined value.

In block S605, when the capacitance change is larger than or equal to the predefined value, the touch sensing control circuit 30 confirms a touch object at a corresponding position of the sensing electrode Rxi as a non-grounding conductor.

In block S606, when the capacitance change is less than the predefined value, the touch sensing control circuit 30 confirms the touch object at a corresponding position of the sensing electrode Rxi as a grounding conductor.

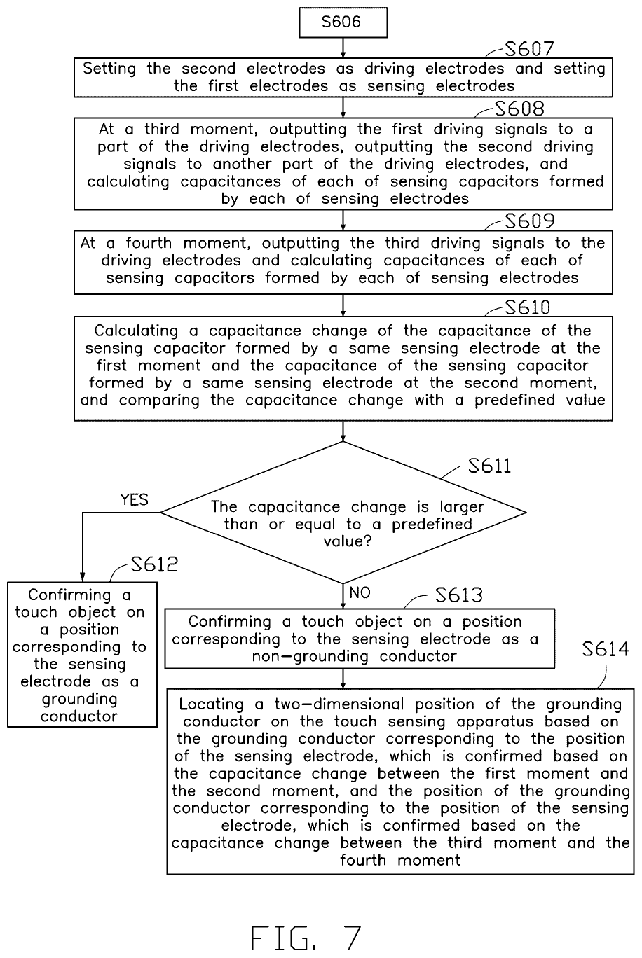

Referring to FIG. 7, FIG. 7 is a flowchart of the touch sensing method. The touch sensing method further includes the following steps.

In block S607, the second electrodes 123_1~123_n are set as the driving electrodes Tx1~Txn, and the first electrodes 121_1~121_n are set as the sensing electrodes Rx1~Rxm.

In block S608, at a third moment t3, the first driving signals DR1 are outputted to a part of the driving electrodes Tx1~Txn, the second driving signals DR2 are outputted to the rest of the driving electrodes Tx1~Txn, and the capacitances of each of the sensing capacitors Si~Sm formed by each of the sensing electrodes Rx1~Rxm are calculated.

In block S609, at a fourth moment t4, the third driving signals DR3 are outputted to each of the driving electrodes Tx1~Txn, and the capacitances of each of the sensing capacitors formed by each of the sensing electrodes Rx1~Rxm.

In one embodiment of the present application, the touch sensing control circuit 30 operates under the first to fourth moments t1~t4 in sequence.

In block S610, a capacitance change of the capacitance of the sensing capacitor Si_t3 formed by a same sensing electrode Rxk at the third moment t3 and the capacitance of the sensing capacitor Si_t4 formed by the same electrodes Rxk at the fourth moment t4 is calculated.

In one embodiment of the present application, the k is a positive integer, which is larger than 1, and less than m.

In block S611, determining whether the capacitance change is larger than or equal to the predefined value.

In block S612, when the capacitance change is larger than or equal to the predefined value, the touch sensing control circuit 30 confirms the touch object at a corresponding position of the sensing electrode Rxk as a non-grounding conductor

In block S613, when the capacitance change is less than the predefined value, the touch sensing control circuit 30 confirms the touch object at a corresponding position of the sensing electrode Rxk as a grounding conductor.

In block S614, a two-dimensional position of the grounding conductor on the capacitive touch sensing apparatus 1 is located based on the position of the sensing electrode Rxk corresponding to the grounding conductor, which is confirmed based on the capacitance change between the first moment t1 and the second moment t2, and the position of the sensing electrode Rxi corresponding to the grounding conductor Rxk, which is confirmed based on the capacitance change between the third moment t3 and the fourth moment t4.

Based on the foregoing touch sensing method, by outputted the driving signals being non in-phase signals to the driving electrodes at one moment in the touch sensing period T1, and outputting driving signals being in-phase signals to each of the driving electrodes, a change degree of the sensing capacitor of a same sensing electrode at different moments are compared. While the change degree of the sensing capacitor is small, the non-grounding conductor is confirmed, for excluding a mis-sensing generated by the non-grounding conductor, therefore a mis-sense generated by the capacitive touch sensing apparatus 1 is avoided, for improving an accuracy in touch sensing of the capacitive touch sensing apparatus 1.

Based on above, the foregoing described embodiments are only exemplary embodiments of this application, and are not intended to limit the scope of this application. Without departing from design spirit of this application, various transformations and improvements made by a person of ordinary skill in the art to the technical solutions of this application shall fall within the protection scope defined in claims of this application.

1. A capacitive touch sensing apparatus comprising a touch panel and a touch sensing control circuit; the touch panel comprises a touch electrode layer; the touch electrode layer is patterned into a plurality of first electrodes disposed along a first direction and a plurality of second electrodes disposed along a second direction, the touch sensing control circuit is electrically connected with the plurality of first electrodes and the plurality of second electrodes; wherein a touch sensing period comprises at least one first moment and at least one second moment; in the at least one first moment and the at least one second moment, the plurality of first electrodes is configured to be driving electrodes, and the plurality of second electrodes is configured to be sensing electrodes; in the at least one first moment, the touch sensing control circuit outputs a first driving signal to each of a portion of the driving electrodes, outputs a second driving signal to each of a remaining portion of the driving electrodes, and calculates a capacitance of each of sensing capacitors formed by the sensing electrodes; in the at least one second moment, the touch sensing control circuit outputs a third driving signal to each of the driving electrodes; the touch sensing control circuit further calculates a capacitance change, of a same capacitor, between the capacitance at the first moment and the capacitance at the second moment, and compares the capacitance change with the predefined value; in a condition that the capacitance change is larger than or equal to the predefined value, the touch sensing control circuit confirms a touch object at a position corresponding to one sensing electrode as a grounding conductor; in a condition that the capacitance change is less than the predefined value, the touch sensing control circuit confirms the touch object at the position as a non-grounding conductor; wherein each of the first driving signal and the second driving signal is a pulse signal, a pulse signal of the each of the first driving signal differs from a pulse signal of each of the second driving signal in at least one of frequency, phase, and amplitude, each of the third driving signal is a pulse signal of a same frequency, a same phase, and a same amplitude.

2. The capacitive touch sensing apparatus of claim 1, wherein the touch sensing period further comprises at least one third moment and at least one fourth moment; the at least one first moment, the at least one second moment, the at least one third moment and the at least one fourth moment time in sequence; in the at least one third moment and the at least one fourth moment, the first electrode are configured to be the sensing electrodes, and the second electrodes are configured to be the driving electrodes; in the at least one third moment, the touch sensing control circuit outputs the first driving signal to each of a portion of the driving electrodes, outputs the second driving signal to each of a remaining portion of the driving electrodes, and calculates the capacitance of each of the sensing capacitors formed by the electrodes; in the at least one fourth moment, the touch sensing control circuit outputs the third driving signal to each of the driving electrodes; the touch sensing control circuit further calculates a capacitance change, of a same capacitor, between the capacitance at the third moment and the capacitance at the fourth moment, and compares the capacitance change with the predefined value; in a condition that the capacitance change is larger than or equal to the predefined value, the touch sensing control circuit confirms a touch object at the position as a grounding conductor; in a condition that the capacitance change is less than the predefined value, the touch sensing control circuit confirms the touch object at the position as a non-grounding conductor; the touch sensing control circuit locates a two-dimensional position of the grounding conductor on the touch sensing apparatus based on the position of the sensing electrode corresponding to the grounding conductor, which is confirmed based on the capacitance change between the first moment and the second moment, and the position of the sensing electrode corresponding to the grounding conductor, which is confirmed based on the capacitance change between the third moment and the forth moment.

3. The capacitive touch sensing apparatus of claim 1, wherein each of the portion of the driving electrodes received the first driving signal from the touch sensing control circuit is an odd number driving electrode of the driving electrodes, and each of the portion of the driving electrodes received the second driving signal from the touch sensing control circuit is an even number driving electrode of the driving electrodes.

4. The capacitive touch sensing apparatus of claim 1, wherein in the first moment, the first driving signal and the second driving signal are outputted to the driving electrodes disposed in a middle of a touch display region of the touch panel respectively; no driving signal is outputted to the driving electrodes disposed on edges of the touch display region.

5. The capacitive touch sensing apparatus of claim 1, wherein in the first moment or in the second moment, the touch sensing control circuit calculates the capacitance of each of the sensing capacitors formed by the sensing electrodes in a time division manner.

6. A touch sensing method, applied in a capacitive touch sensing apparatus; the capacitive touch sensing apparatus comprises a touch panel and a touch sensing control circuit; the touch panel comprises and a touch electrode layer; the touch electrode layer is patterned into a plurality of first electrodes disposed along a first direction and a plurality of second electrodes disposed along a second direction, the touch sensing control circuit is electrically connected with the plurality of first electrodes and the plurality of second electrodes; the touch sensing control circuit is configured to electrically connected with the first electrodes and the second electrodes; the touch sensing method comprises:
setting first electrodes as driving electrodes, and setting second electrodes as sensing electrodes;
at a first moment, outputting a first driving signal to each of a portion of the driving electrodes, outputting a second driving signal to each of a remaining portion of the driving electrodes, and calculating a capacitance of each of sensing capacitors formed by the sensing electrodes;
at a second moment, outputting third driving electrodes to each of the driving electrodes and calculating the capacitance of each of the sensing capacitors formed by the sensing electrodes;
calculating a capacitance change, of a same capacitor, between the capacitance at the first moment and the capacitance at the second moment;
determining whether the capacitance change is larger than or equal to a predefined value;
in a condition that the capacitance change is larger than or equal to the predefined value, confirming a touch object at a position corresponding to one sensing electrode as a grounding conductor; and
in a condition that the capacitance change is less than the predefined value, confirming the touch object at the a position as a non-grounding conductor;
wherein each of the first driving signal and the second driving signal is a pulse signal, a pulse signal of the each of the first driving signal differs from a pulse signal of each of the second driving signal in at least one of frequency, phase, and amplitude, each of the third driving signal is a pulse signal of a same frequency, a same phase, and a same amplitude.

7. The touch sensing method of claim 6, wherein the touch sensing method further comprises:
setting the second electrodes as driving electrodes and setting the first electrodes as sensing electrodes;
in a third moment, outputting the first driving signal to a portion of the driving electrodes, outputting the second driving signal to each of a remaining portion of the driving electrodes, and calculating the capacitance of each of sensing capacitances formed by the sensing electrodes;
in a fourth moment, outputting the third driving signal to each of the driving electrodes and calculating the capacitance of each of the sensing capacitances formed by each of sensing electrodes;
calculating a capacitance change, of a same capacitor, between the capacitance at the third moment and the capacitance at the fourth moment;
determining whether the capacitance change is larger than or equal to the predefined value;
in a condition that the capacitance change is larger than or equal to the predefined value, confirming a touch object at the position as a grounding conductor;
in a condition that the capacitance change is less than the predefined value, confirming the touch object at the position as a non-grounding conductor; and
locating a two-dimensional position of the grounding conductor on the touch sensing apparatus based on the position of the sensing electrode corresponding to the grounding conductor, which is confirmed based on the capacitance change between the first moment and the second moment, and the position of the sensing electrode corresponding to the grounding conductor, which is confirmed based on the capacitance change between the third moment and the forth moment.

8. The touch sensing method of claim 6, wherein outputting a first driving signal to each of a portion of the driving electrodes comprise outputting the first driving signal to each odd number driving electrode of the driving electrodes, and outputting the second driving signal to each even number driving electrode of the driving electrodes.

9. The touch sensing method of claim 6, wherein at the first moment, the first driving signal and the second driving signal are outputted to the driving electrodes disposed in a middle of a touch display region respectively; no driving signal is outputted to the driving electrodes disposed on edges of the touch display region.

10. The touch sensing method of claim 6, wherein calculating a capacitance of each of the sensing capacitors formed by the sensing electrodes at the first moment is calculated in a time division manner; or, the touch sensing control circuit further comprising calculating a capacitance of each of the sensing capacitors formed by the sensing electrodes at the second moment in the time division manner.
